(19) United States
(12) Patent Application Publication
(10) Pub. No.: US 2003/0160472 A1
(43) Pub. Date: Aug. 28, 2003

(54) Integrated splash shield and air intake system

(75) Inventors: Zhouxuan Xia, Windsor (CA); James Kenneth Vanderveen, Blenheim (CA)

Correspondence Address: SIEMENS CORPORATION, INTELLECTUAL PROPERTY LAW DEPARTMENT, 170 WOOD AVENUE SOUTH, ISELIN, NJ, 08830, US

(73) Assignee: Siemens Canada Limited

(21) Appl. No.: 10/360,075

(22) Filed: Feb. 6, 2003

Related U.S. Application Data
(60) Provisional application No. 60/359,772, filed on Feb. 26, 2002.

(51) Int. Cl. B60N 2/10

(52) U.S. Cl. 296/65.09

(57) ABSTRACT

A invention provides an integrated splash shield and air intake tube are provided. A splash shield defining a wheel well is at least partially arranged about a wheel. The splash shield has first and second portions secured to one another defining an air passageway with the air passageway in fluid communication with the engine. A wheel well portion has a second surface opposite a first surface. An air intake portion is supported on the wheel well portion and preferably secured thereto by a weld bead. The air intake portion and the first surface of the wheel well portion together define an air passageway having an inlet for receiving ambient air and an outlet for connection to an engine throttle of the engine. Other air passages may be defined in a similar manner in the integrated splash shield and air intake tube described above. For example, a passive noise cancellation system such as a Herschel-Quincke tube arrangement may be formed by the wheel well and air intake portions. The integrated splash shield and air intake tube may be formed by any suitable plastic forming process, such as by blow or injection molding. The wheel well and air intake portions may be constructed from numerous pieces and secured to one another by a weld bead.

### RELATED APPLICATIONS

This application claims priority to U.S. Provisional Application No. 60/359,772, filed on Feb. 26, 2002.

### BACKGROUND OF THE INVENTION

This invention relates to a splash shield and an air intake system, and more particularly, the invention relates to an integrated splash shield and air intake system, which may incorporate noise cancellation ductwork. Splash shields are typically simple C-shaped plastic structures arranged in each wheel well above the wheels to prevent water and debris from entering the engine compartment.

Vehicle air intake systems route air from the environment to the engine for use in the combustion process. Air intake systems include a tube with an opening, typically located at the front of the vehicle proximate to the radiator, extending to the engine throttle. Various passive or active noise cancellation systems may be connected to the air intake and are located within the engine compartment, which because of their size may be difficult to package within the tight confines of modern engine compartments. Furthermore, increasing demands have been placed upon engine compartment space due to styling considerations and additional vehicle systems components.

Quarter wave tubes and Helmholtz resonators are commonly used to generate noise canceling pressure waves in passenger vehicles. Another type of passive noise cancellation structure is a Herschel-Quincke (HQ) tube, which provides superior noise cancellation to other passive noise cancellation systems. However, HQ tubes cancel noise over a broader frequency band than either quarter wave tubes or Helmholtz resonators. HQ tubes have not been used in passenger vehicle applications because they require a very large amount of space—much more space than is available within the confines of the engine compartment. Therefore, what is needed is a way of incorporating a noise cancellation system, such as an HQ tube, into a passenger vehicle to provide improved noise cancellation and increased space within the engine compartment.

### SUMMARY OF THE INVENTION AND ADVANTAGES

This invention provides an integrated splash shield and air intake tube. More specifically, the present invention provides a frame and a body that defines an engine compartment. An engine is arranged within the engine compartment. A splash shield defining a wheel well is at least partially arranged about a wheel. The splash shield has first and second portions secured to one another defining an air passageway with the air passageway in fluid communication with the engine. In particular, the splash shield includes a wheel well portion having a generally C-shaped surface for accommodating the wheel. The wheel well portion has a second surface opposite the first surface. An air intake portion is supported on the wheel well portion and preferably secured thereto by a weld bead. The air intake portion and the first surface of the wheel well portion together define an air passageway having an inlet for receiving ambient air and an outlet for connection to an engine throttle of the engine. Other air passages may be defined in a similar manner and integrated with the splash shield and air intake tube described above. For example, a passive noise cancellation system such as a Herschel-Quincke tube arrangement may be formed by the wheel well and air intake portions.

The integrated splash shield and air intake tube may be formed by any suitable plastic forming process, such as by blow or injection molding. The wheel well and air intake portions may be constructed from numerous pieces and secured to one another by a weld bead.

Accordingly, the above invention provides a way of incorporating a noise cancellation system, such as an HQ tube, into a passenger vehicle to provide improved noise cancellation and increased engine compartment space.

### BRIEF DESCRIPTION OF THE DRAWINGS

Other advantages of the present invention can be understood by reference to the following detailed description when considered in connection with the accompanying drawings wherein:

FIG. 1 is a side view of a passenger vehicle incorporating the present invention integrated splash shield and air intake tube;

FIG. 2 is a top elevational perspective view of the present invention integrated splash shield and air intake tube;

FIG. 3 is a top elevational perspective view of the wheel well portion shown in FIG. 2;

FIG. 4 is a bottom elevational perspective view of a first cap of the air intake portion shown in FIG. 2;

FIG. 5 is a bottom elevational perspective of a second cap of the air intake portion shown in FIG. 2;

FIG. 6 is a bottom elevational perspective view of a third cap of the air intake portion shown in FIG. 2;

FIG. 7 is a bottom elevational perspective view of a fourth cap of the air intake portion shown in FIG. 2;

FIG. 8 is a schematic view of an HQ tube for a passive noise cancellation system as shown in the integrated splash shield and air intake tube depicted in FIG. 2.

### DETAILED DESCRIPTION OF THE PREFERRED EMBODIMENT

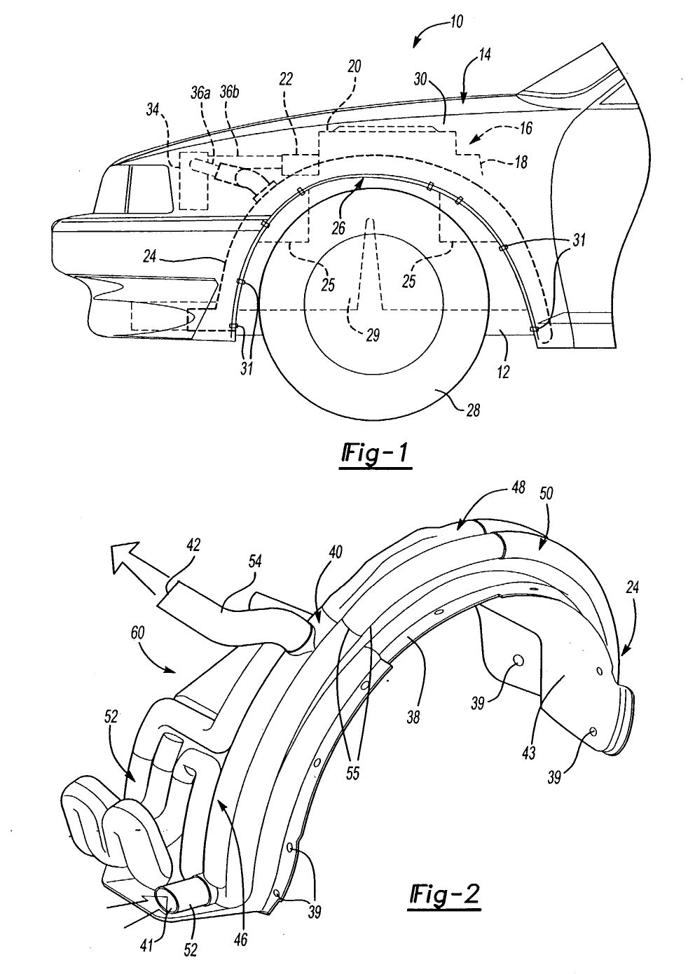

A vehicle 10 incorporating the present invention integrated splash shield and air intake tube is shown in FIG. 1. The vehicle 10 includes a frame 12 and a body 14 supported on the frame 12. The frame 12 and body 14 together define an engine compartment 16 at the forward end of the vehicle 10. However, it is to be understood that the present invention may be utilized in a different location, for example, at the rear of the vehicle for rear engine configurations. The vehicle 10 includes an engine 18 having an intake manifold 20 and throttle 22 disposed within the engine compartment 16, as is well known in the art. An air cleaner box 34 may be connected between the present invention splash shield 24 and the throttle 22 of the engine 18 by tubing 36a and 36b.

A splash shield 24 is arranged between the engine compartment 16 and a body fender 30 to define a wheel well 26. The splash shield 24 is C-shaped and arranged at least partially around a wheel 28 to prevent water and debris from entering the engine compartment 16. The splash shield 24 includes spaced apart downwardly extending flanges 25 that supports a rubber flap 29 arranged between the wheel 28 and the engine compartment 16, as is known in the art, to provide a further barrier to water and debris. The fender 30 is secured to the splash shield 24 by fasteners 31 so that the splash shield 24 provides structural support for at least a portion of the fender 30.

The present invention provides an integrated splash shield and air intake tube to free up space within the engine compartment 16. While the present invention is described as incorporating an HQ tube, it is also to be understood that other noise cancellation systems may be incorporated with the splash shield such as quarter wave tubes, or Helmholtz resonators. The present invention splash shield provides the unique ability of incorporating an HQ tube because of the large surface it provides. More particularly, HQ tubes require a considerable length of tubing, which prior to the present invention was difficult to incorporate given the limited space within the engine compartment.

Referring to FIG. 2, the splash shield 24 includes a first wheel well portion 38 and a second air intake portion 40 supported on and secured to the first wheel well portion 38, preferably by weld beads 55. Wheel well portion 38 has a first c-shaped surface 43 that is adjacent to the wheel 28. A second surface 44 is arranged opposite the first surface 43 and defines portions of the air passageways. Referring to FIGS. 2-4, the splash shield 24 includes an inlet 41 that preferably opens in a forward direction relative to vehicle travel to provide a ram air effect. The inlet 41 has an air passageway extending to an outlet 42 that may be connected to the throttle 22 by other tubing and ductwork. The air intake portion 40 may include caps 46, 48, 50, and 52 that together define the air passageways along with the wheel well portion 38. Additional tubes 52 and 54 may be welded to the air intake portion 40 as part of the integrated splash shield 24.

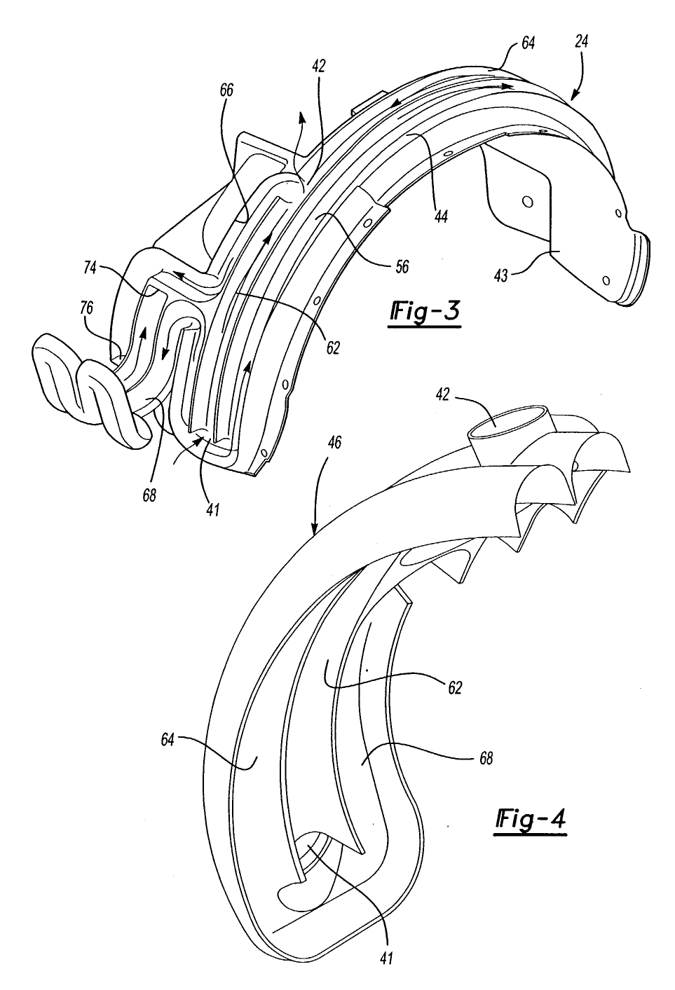

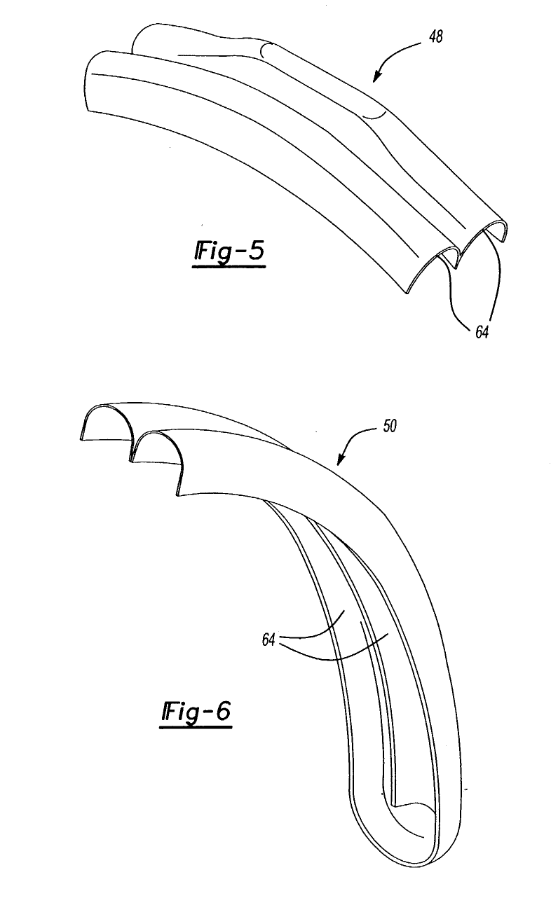

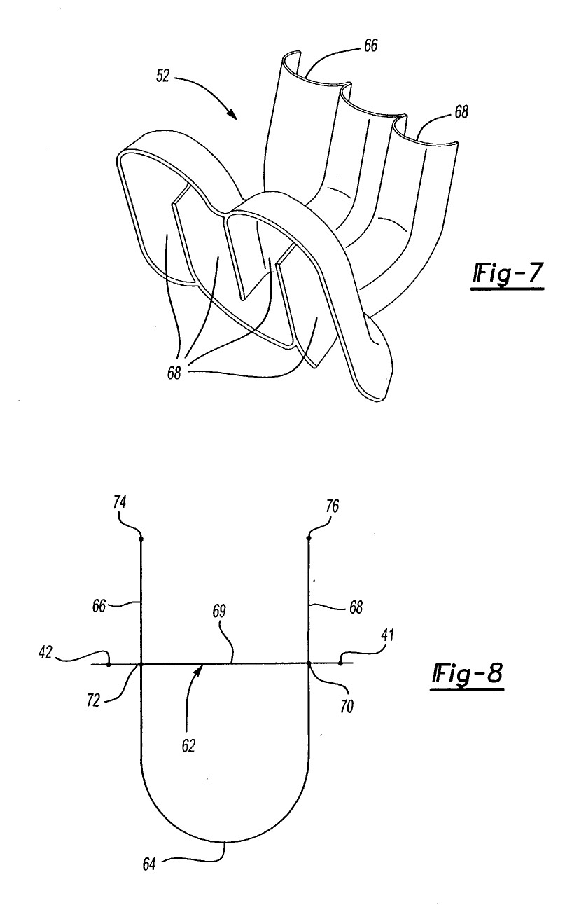

Referring to FIGS. 3-7, the wheel well portion 38 provides a first circumferential half 56 of the air passageways while the air intake portion 40 provides the second circumferential half 58 of the air passageways. An air passageway 62 extends from the inlet 41 from the outlet 42 to provide air from the environment to the engine 18 for the combination process. A noise cancellation system 60 may also be incorporated into the present invention splash shield 24 to take advantage of the space provided by the splash shield 24 outside of the engine compartment 16. An active or passive noise cancellation system may be fluidly connected to the air passageway 62 and at least partially formed by the wheel well portion 38 and the intake tube portion 40. For example, it is desirable to incorporate an HQ tube to the splash shield 24 because it provides noise cancellation over a broader range of frequency than that of quarter wave tubes or Helmholtz resonators. HQ tubes have not been incorporated into passenger vehicle applications because of the limited space within the engine compartment 16.

An HQ tube arrangement includes a long passageway that intersects the air passageway 62 extending from the inlet 41 to the outlet 42. More specifically, an HQ tube arrangement includes a first passage 54 intersecting the air passageway 62 at spaced apart nodes 70 and 72. A second passage 66 extends from one node and a third passage 68 extends from the other node. A portion 69 of the air passageway 62 defines a length between the first 70 and second 72 nodes.

A desired noise cancellation frequency is selected for the noise cancellation system. For example, it may be desirable to cancel noise at 90 Hz. Because of the broad frequency of noise cancellation that an HQ tube provides, noise may be cancelled as low as 60 Hz and as high as 120 Hz for a target frequency of 90 Hz. Once the desired noise cancellation frequency has been selected, the lengths of the passages 64, 66, 68, and the portion 69 may be determined. The equation below is used in determining the lengths:

$$λ = \frac{c}{f} \qquad where$$

$$\begin{matrix}λ - wave length \\ c = Speed of sound \\ f = T a rget frequency\end{matrix}$$

For a typical HQ tube arrangement, the length of the portion 69 is

$$\frac{γ}{2}$$

and the length of the first passage 64 is λ such that the noise cancellation wave within the first passage 64 is 180° out of phase with the pressure wave traveling in the air passage 62. Typically, the lengths of the second and third passages 66 and 68 are

$$\frac{γ}{4}$$

and respectively terminate at ends 76 and 74 so they act as quarter wave tubes. It should be understood, however, that the lengths of the passages may be revised to fine tune the noise cancellation provided by the HQ tube. For example, for a particular configuration with 46 mm diameter passageways the length of the first passage 64 may be 2.32 meters, the length of the second passage 66 may be 0.53 meters, the length of the third passage 68 may be 1.37 meters, and the length of the portions 69 may be 0.46 meters.

To further enhance packaging, portions of the noise cancellation system 60 may extend transversely from a plane tangential to the first surface 43, such as the fourth cap 52 shown.

The present invention may be constructed from plastic using any suitable molding process. For example, an injection or blow molding process may be used. One suitable plastic may be a 20% talc filled polypropylene. The plastic pieces are welded together using any suitable process.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A vehicle component comprising:
a wheel well portion having a generally C-shaped first surface for accommodating a wheel, said wheel well portion having a second surface opposite said first surface; and
an air intake portion supported on said wheel well portion, said air intake portion and said first surface of said wheel well portion together defining an air passageway having an inlet for receiving ambient air and an outlet for connection to an engine throttle.

2. The vehicle component according to claim 1, wherein said portions are constructed from plastic with a weld bead securing said portions together.

3. The vehicle component according to claim 1, wherein said portions further define a noise cancellation conduit portion in fluid communication with said air passageway for providing noise cancellation.

4. The vehicle component according to claim 3, wherein said portions define a Hershel-Quincke tube in fluid communication with said air passageway.

5. The vehicle component according to claim 4, wherein said Herschel-Quincke tube has a first passage with opposing ends fluidly intersecting said air passageway at spaced apart nodes, said Herschel-Quincke tube including second and third passages respectively extending from and in fluid communication with said nodes with said second and third passages terminating in terminal ends.

6. The vehicle component according to claim 5, wherein at least a portion of one of said passages extends transversely from a plane tangential to said first surface of said splash shield.

7. The vehicle component according to claim 4, wherein said wheel well portion generally defines a first circumferential half of said air passageway and said Herschel-Quincke tube and said air intake portion generally defines a second circumferential half of said air passageway and said Herschel-Quincke tube.

8. The vehicle component according to claim 7, wherein air intake portion includes a plurality of pieces secured to said wheel well portion together defining said Herschel-Quincke tube.

9. The vehicle component according to claim 1, wherein a side of said wheel well portion includes a plurality of apertures for receiving fasteners securing the vehicle component to a fender.

10. A vehicle comprising:
a frame and body defining an engine compartment with an engine disposed in said engine compartment; and
a splash shield defining a wheel well at least partially disposed about a wheel, said splash shield having first and second portions secured to one another together defining an air passageway with said air passageway in fluid communication with said engine.

11. The vehicle according to claim 10, wherein said body includes a fender with said splash shield supporting said fender.

12. The vehicle according to claim 10, wherein said body includes a forward end with an inlet of said air passageway opening toward said forward end for providing a ram air effect.

13. The vehicle according to claim 10, wherein said portions further define a noise cancellation conduit portion in fluid communication with said air passageway for providing noise cancellation.

14. The vehicle according to claim 13, wherein said noise cancellation conduit portion is fluidly connected to a passive noise cancellation system.

15. The vehicle according to claim 14, wherein said passive noise cancellation system is a Hershel-Quincke tube in fluid communication with said air passageway.

16. A method of forming a splash shield comprising the steps of:
a) forming a wheel well portion;
b) forming an air intake portion; and
c) securing the air intake portion to the wheel well portion to define an air passageway.

17. The method according to claim 16, wherein the wheel well portion is generally C-shaped.

18. The method according to claim 16, wherein the air intake portion includes a plurality of pieces.

19. The method according to claim 16, wherein at least one of the portions of steps a) and b) are constructed from plastic.

20. The method according to claim 19, wherein at least one of the portions of steps a) and b) are formed using an injection molding process.

21. The method according to claim 19, wherein at least one of the portions of steps a) and b) are formed using a blow molding process.

22. The method according to claim 16, wherein step c) includes welding the portions to one another.
